(19) United States
(12) Patent Application Publication
(10) Pub. No.: US 2009/0242108 A1
(43) Pub. Date: Oct. 1, 2009

(54) METHOD OF MANUFACTURING PRINTED AND LAMINATED BED AND BED LINER

(75) Inventors: John C. Montagna, Metamora, MI (US); Donald J. LaBelle, Macomb Township, MI (US); Gary J. Nehring, Linden, MI (US)

Correspondence Address: FLASTER/GREENBERG P.C.;Four Penn Center, 1600 John F. Kennedy Boulevard, 2nd Floor, PHILADELPHIA, PA, 19103, US

(73) Assignee: Durakon Industries, Inc., Lapeer, MI (US)

(21) Appl. No.: 12/393,880

(22) Filed: Feb. 26, 2009

Related U.S. Application Data
(63) Continuation of application No. 10/401,423, filed on Mar. 28, 2003, now abandoned.

(51) Int. Cl. B29C 51/02; B32B 38/14; B29C 47/00

(52) U.S. Cl. 156/244.19

(57) ABSTRACT

A method of manufacturing a printed, laminated pickup truck bed and bed liner includes the steps of forming by extrusion or another process a single or double layer substrate of a desired thickness and strength. If a single layer, it will preferably be formed of a thermoplastic material such as high density polyethylene (HDPE). If a double layer, the lower layer may be HDPE or HDPE reinforced with random fibers or a fibrous material to improve its strength and ruggedness. Additionally, a cast or blow film upon which may be printed a desired pattern such as, for example, camouflage or indicia, is utilized as the top layer of the material. The two or three layers are laminated together either with or without the use of an adhesive and then formed into a bed or bed liner by a thermoforming process.

### BACKGROUND OF THE INVENTION

The invention relates to a method of manufacturing beds and bed liners for pickup trucks, cargo vehicles and the like and more particularly to a method of printing, laminating and thermoforming beds and bed liners.

Liners for motor vehicle cargo compartments, particularly bed liners for pickup trucks and cargo vans provide many benefits. First of all, such bed liners provide a resilient barrier between the cargo area and the actual truck bed which absorbs energy and reduces denting and damage to the bed when heavy loads are transported. Second of all, such liners protect the vehicle bed or interior from water, salt and other possibly more corrosive materials which maybe carried in the vehicle or to which the vehicle and vehicle bed are exposed.

The emphasis on passenger car weight reduction has created a similar emphasis on behalf of manufacturers of light and medium duty trucks. One of the areas that has become a focus of such weight reduction is the vehicle box or bed. Replacing the metal box or bed with a non-metal, e.g., thermoplastic material, bed provides obvious and relatively significant weight reduction and other advantages. Resistance to rusting is just one accompanying advantage.

One drawback that accompanies components made from thermoplastic or other organic materials is their ability to become electrically charged and their inability to quickly dissipate such charges. This electrical activity is viewed as undesirable and products which do not exhibit this characteristic would therefore be desirable.

Truck bed liners having charge dissipating and anti-skid characteristics which are formed from a co-formed or co-extruded two layer sheet are known. A drawback of bed liners formed of co-formed or co-extruded sheets is the inability to control the individual thicknesses of the layers since only the total thickness of the sheet or panel may be readily controlled. Furthermore, only two layer sheets for bed liners have successfully been co-formed although a three layer sheet and product would be desirable. The present invention addresses these problems.

### SUMMARY OF THE INVENTION

A method of manufacturing a printed, laminated pickup truck bed and bed liner having a printed or colored upper surface includes the steps of forming by extrusion or another process a single or double layer substrate of a desired thickness and strength. If a single layer, it will preferably be formed of a thermoplastic material such as high density polyethylene (HDPE). If a double layer, the lower layer may be HDPE or HDPE reinforced with random fibers or a fibrous material to improve its strength and ruggedness. The upper layer may be a thermoplastic material such as HDPE and may include dispersed conductive material such as carbon particles, carbon, fibers or conductive polymers which dissipate or carry static electrical charges to a vehicle ground. Additionally, a cast or blow film upon which may be colored or printed with a desired pattern such as, for example, camouflage, or indicia, is utilized as the top layer of the material. All manner of single or multiple colors, patterns, indicia, commercial logos and the like may be printed on the film. The two or three layers are laminated together either with or without the use of an adhesive and then formed into a bed or bed liner by a thermoforming process. Independent manufacture of the extruded layers and the cast or blown film provides greatly improved control of the thickness of the individual layers and therefore achieves more predictable product characteristics such as appearance, strength and electrical conductivity.

Thus, it is an object of the present invention to provide a method of manufacturing a laminated pickup truck bed or bed liner having an upper thin film layer with a printed pattern or indicia appearing thereon.

It is a further object of the present invention to provide a method for fabricating a bed or bed liner having two or three structural layers and an upper thin film layer having single or multi-colored printing of a pattern or indicia thereupon.

It is a still further object of the present invention to provide a bed or bed liner fabricated of one or two layers of material having an upper thin film layer including single or multiple color printed indicia or patterns.

Further objects and advantages of the present invention will become apparent by reference to the following description of the preferred embodiments and appended drawings wherein like reference numbers refer to the same component, element or feature

### BRIEF DESCRIPTION OF DRAWINGS

FIGS. 1A, 1B and 1C schematically illustrate three manufacturing processes for producing two layer laminated thermoplastic sheets or panels by first independently extruding two layers and subsequently securing them together;

FIG. 1D is an optional heating step for raising the temperature of the laminated sheets or panels prior to thermoforming;

FIGS. 1E and 1F schematically illustrate the thermoforming of a bed or bed liner from a laminated sheet within a mold by the application of vacuum to one side of the laminated sheet and pressure to the other;

FIGS. 1G and 1H schematically illustrate the thermoforming of a bed liner from a laminated sheet within a mold having an outer vacuum mold and forming insert;

FIGS. 2A and 2B schematically illustrate two distinct manufacturing processes for producing three layer laminated thermoplastic sheets or panels by first independently extruding three layers and subsequently securing them together;

FIG. 3 schematically illustrates a manufacturing process for producing a two layer laminated sheet having a first or upper skin or film made by blow forming which is secured to a second or lower extruded layer;

FIG. 4 schematically illustrates a process for producing a three layer laminated sheet having a first or upper skin or film made by cast forming which is secured to a second intermediate extruded layer;

FIG. 5 is a perspective view of a pickup truck having a non-metallic box or bed according to a first embodiment of the present invention;

FIG. 6 is a greatly enlarged, fragmentary, sectional view of a truck bed according to the first embodiment of the present invention taken along line 4-4 of FIG. 3;

FIG. 7 is a greatly enlarged, fragmentary, sectional view of a truck bed according to a second embodiment of the present invention taken along line 4-4 of FIG. 3;

FIG. 8 is a perspective view of a pickup truck and conventional metal box or bed having a non-metallic bed liner according to a third embodiment of the present invention;

FIG. 9 is a greatly enlarged, fragmentary, sectional view of a bed liner according to the third embodiment of the invention taken along line 7-7 of FIG. 6;

FIG. 10 is a greatly enlarged, fragmentary, sectional view of a bed liner according to a fourth embodiment of the present invention taken along line 7-7 of FIG. 6;

FIG. 11 schematically illustrates a manufacturing process for producing a two layer laminated sheet having a first or upper skin or film with a pattern, printing or indicia on its upper (outer) surface made by blow forming which is secured to a second or lower extruded layer;

FIG. 12 schematically illustrates an alternate embodiment manufacturing process for producing a two layer laminated sheet having a first or upper skin or film with a pattern, printing or indicia on its lower (inner) surface made by blow forming which is secured to a second or lower extended layer.

FIG. 13 schematically illustrates a manufacturing process for producing a three layer laminated sheet having a first or upper skin or film made by cast forming which is secured to a second, intermediate extruded layer which, in turn, are secured to a third, lower extruded layer; and

FIG. 14 is a diagrammatic, plan view illustrating an exemplary multi-color camouflage pattern utilized in the present invention.

### DETAILED DESCRIPTION OF THE PREFERRED AND ALTERNATE EMBODIMENTS

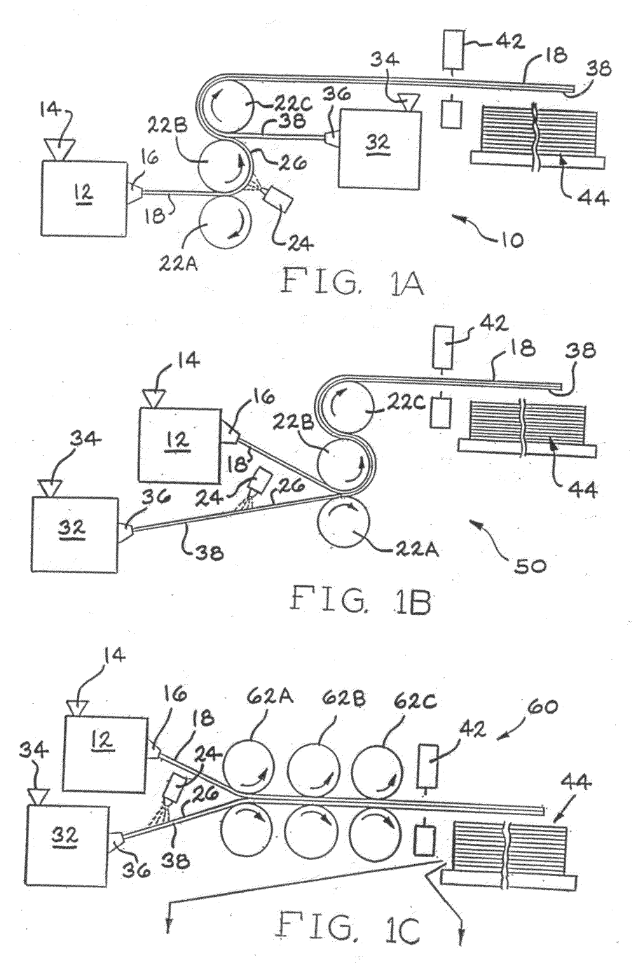

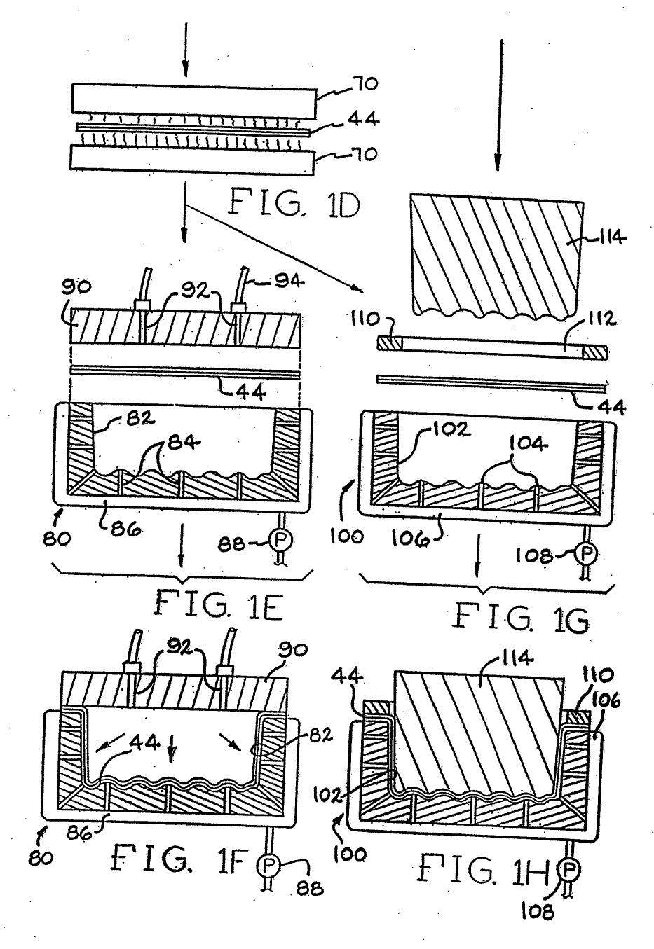

Referring now to FIGS. 1A, 1B and 1C, three manufacturing processes for the manufacture of two layer, laminated thermoformable sheets are illustrated. In FIG. 1A, a preferred embodiment extruding and laminating manufacturing process 10 which is carried out by a first extruding machine 12 includes a hopper 14 which may be filled with a supply of thermoformable material such as high density polyethylene (HDPE), thermoplastic olefin (TPO) or other similar polymer or plastic material. The first extruding machine 12 includes an elongate, horizontal extruding nozzle 16 having a width at least as great as the desired width of the extruded material 18. The extruded material 18 exits the extruding nozzle 16 which accurately controls its thickness.

The extruded material 18 is received within a nip between two vertically aligned, horizontal, contra-rotating rollers 22A and 22B. The two rollers 22A and 22B are preferably somewhat wider than the width of the extruded material 18. The two rollers 22 not only draw the extruded material 18 from the extruding machine 12 but also accurately control the thickness of the extruded material 18. After passage of the extruded material 18 between the first two rollers 22A and 22B, an elongate, horizontal spray bar having a plurality of spray nozzles 24, one of which is illustrated in FIG. 1A, may provide a coating or layer of a suitable adhesive 26 to one surface of the extruded material 18. It will be appreciated that the use of an adhesive 26 as a tying layer is optional and depends upon the compositions of the various layers to be laminated together, specifically the degree to which such layers can be autogeneously bonded, and furthermore the degree to which such layers must be secured together.

A second extruding machine 32 includes a hopper 34 which receives material which will typically be different from the material provided to the hopper 14 of the first extruding machine 12 but may be the same. For example, either the first extruding machine 12 or the second extruding machine 32 may be supplied with a thermoplastic material having reinforcing fibers of, for example, fiberglass, homogenously mixed throughout the material to improve its strength and ruggedness. Assuming the orientation of the material is maintained throughout production, such that the lower layer 38 in FIG. 1A becomes the lower layer of a product, typically the lower layer of extruded material 38 will include such random fiber reinforcing or other reinforcement such as a fibrous mat fed into the second extruding machine 32 such that it resides approximately in the middle of the extruded material 38 as it exits the extruding nozzle 36. Similarly, the upper extruded layer 18 of the product may, for example, be rendered electrically conductive by the addition of conductive material such as carbon fibers, carbon particles, metal particles or conductive polymers, or contain material or undergo surface treatment such as graining by the roller 22B which enhances its frictional characteristics.

In any event, the first extruded material layer 18 and the second extruded material layer 38 are provided to the nip between the second roller 22B and the third roller 22C. The selected separation between the surfaces of the rollers 22B and 22C compresses the adhesive 26, if utilized, thereby securing the two extruded material layers 18 and 38 together and accurately controls the overall thickness of the laminated material layers. If the adhesive 26 is not utilized, compression of the layers 18 and 38 by the rollers 22B and 22C intimately bonds the layers together by autogenous bonding. The laminated, extruded material layers 18 and 38 then pass through a cutter or cutting station 42 which cuts the continuous laminated extruded material into sheets or panels 44 having an appropriate length for subsequent production activity and products.

Referring now to FIG. 1B, a first alternate embodiment extruding and laminating process 50 is illustrated. The first alternate embodiment process 50 is identical in most respects to the preferred embodiment manufacturing process 10 with the exception that the extruded material is fed through the stack of rollers 22A, 22B and 22C somewhat differently. As such, the first alternate embodiment process 50 includes a first extruding machine 12 having a hopper 14 and an elongate, horizontal extrusion nozzle 16 which produces a continuous web or sheet of extruded material 18 of accurate thickness. Similarly, the process includes a second extruding machine 32 having a hopper 34 and an elongate, horizontal extrusion nozzle 36 which produces a continuous web or sheet of extruded material 38 also of accurate thickness. Optionally, an elongate, horizontal spray bar having a plurality of nozzles, one of which is illustrated in FIG. 1B, provides an adhesive layer 26 to one surface of the second extruded material layer 38 prior to the two layers of extruded material 18 and 38 passing through the nip of the vertically aligned, horizontal, contra-rotating rollers 22A and 22B. Next the continuous web or sheet of extruded material 18 and 38 passes through a second nip between the contra-rotating rollers 22B and 22C. In this configuration, both of the extruded material layers 18 and 38 pass between adjacent rollers 22A and 22B and 22B and 22C twice and the process thus produces a laminated sheet having improved thickness control relative to the preferred embodiment process 10. Then the extruded and laminated material layers 18 and 38 pass through a cutter or cutting assembly 42 and are cut into uniform desired lengths of sheets or panels 44.

Referring to FIG. 1C, a second alternate embodiment extruding and laminating process 60 is illustrated. Once again, there are significant similarities to the second alternate embodiment process 50 illustrated in FIG. 1B and the preferred embodiment process 10 illustrated in FIG. 1A. Thus, the second alternate embodiment extruding and laminating process 60 includes a first extruding machine 12 having a first hopper 14 and an elongate horizontal extruding nozzle 16 which produces a continuous extruded material layer 18 of accurate thickness. A second extruding machine 32 includes a hopper 34 and a horizontal elongate extruding nozzle 36 which produces a second extruded material layer 38. A horizontal spray bar having a plurality of nozzles 24, one of which is illustrated in FIG. 1C, may be optionally utilized to disperse an adhesive 26 onto one surface of the extruded material layer 38. Two pairs of vertically aligned, horizontal, contra-rotating rollers 62A and 62B receive the extruded material layers 18 and 38, intimately secure them together and compress them to a desired thickness. If desired, a third set of vertically aligned, horizontal contra-rotating rollers 62C may include graining, texturing or other surface treatment on the exterior surface of one or both of the rollers 62C to emboss or impress such surface treatment onto one or both of the exterior surfaces of the laminated material layers 18 and 38. The second alternate embodiment process 60 thus provides the option of graining, texturing or other surface treatment as well as producing a product, sheet or panel 44 of improved thickness accuracy due to not only to individual extrusion of each of the layers 18 and 38 but also multiple passes between the rollers 62A, 62B and 62C. Finally, a cutter or cutting assembly 42 cuts the continuous laminated layers 18 and 38 into sheets or panels 44 of a desired length.

Inasmuch as the continuous extruded sheets 18 and 38 are at an elevated temperature of several hundred degrees Fahrenheit as they exit the extruding machines 12 and 32, respectively, when the sheets or panels 44 are stacked after the cutter 42 they will still be at a significantly elevated temperature. If they are then utilized promptly in the thermoforming steps discussed below and identified in the drawings as FIGS. 1E through 1H, the amount of reheat required can be significantly reduced. However, if the sheets or panels 44 are stacked and allowed to cool, either in the short term (several hours) or for days, weeks or months by virtue of storage in a warehouse, the sheets or panels 44 must be reheated to a sufficient temperature to ensure that the sheets or panels 44 are sufficiently flexible and formable for the thermoforming process.

FIG. 1D schematically illustrates a heating step where the temperature of the sheets or panels 44 may be elevated preparatory to thermoforming. A pair of horizontal, parallel and spaced apart heaters 70 which may include forced air or radiant heating assemblies supplied with, for example, gas or electricity, receive a sheet or panel 44 for a sufficient time to raise it to an elevated temperature, as noted above, several hundred degrees Fahrenheit. When the sheet or panel 44 has been raised to a sufficient temperature, it may be thermoformed by one of the two processes described below or another comparable or analogous thermoforming process.

Turning then to FIGS. 1E and 1F, a vacuum and pressure forming process is illustrated. The process utilizes a vacuum die or mold assembly 80 having an interior or female mold surface 82 which precisely reproduces the desired outer form and configuration of a product such as a truck bed or bed liner. The mold surface 82 includes a plurality of vacuum passageways 84 which lead from the mold surface 82 to a vacuum plenum 86. The vacuum plenum 86 surrounds the mold assembly 80 and is in communication with a vacuum pump 88 which draws a partial vacuum in the plenum 86 and draws air through the vacuum ports 84. A sheet or panel 44 at an elevated temperature is placed upon the mold assembly 80 and a mold plate or cover 90 having a size which is coextensive with the size of the mold assembly 80 is positioned on top of the sheet or panel 44 which is positioned on top of the mold assembly 80. Pressurized air is provided to a plurality of pressure ports 92 through a plurality of flexible hoses 94. The vacuum pump 88 is activated and a vacuum is drawn on the lower surface of the sheet or panel 44 and the pressure applied to the upper surface of the sheet or panel 44 and the vacuum drawn on the lower surface of the sheet or panel 44 forms it into intimate contact with the mold surface as illustrated in FIG. 1F.

Referring now to FIGS. 1G and 1H, an alternate thermoforming process is illustrated. As an alternative to forming a product such as a bed liner through vacuum and pressure forming as illustrated in FIGS. 1E and 1F, a product may be formed through the use of male and female mold segments which are either fixed or, particularly in the case of the male mold segment may include moveable corner sections or other moveable features such as bladders which may facilitate separation of the molds segments and/or improve the uniform distribution of material within the mold and the finished product. FIGS. 1G and 1H schematically present such a process.

This process utilizes a conventional female mold assembly 100 having an interior surface 102 which corresponds to the exterior size and configuration of the final molded product. The mold assembly 100 includes a plurality of through passageways 104 which communicate between the interior mold surface 102 and a vacuum plenum 106 which surrounds the mold assembly 100. The plenum 106 is in communication with a vacuum pump 108 which, according to conventional practice, draws a distributed vacuum over the interior surface 102 of the mold assembly 100.

The alternate thermoforming process utilizes a laminated sheet or panel 44 which is placed above the mold assembly 100 and beneath a clamping frame 110 which engages the sheet or panel 44 about a region adjacent its peripheral edge and clamps the sheet or panel 44 to the mold so that it is stretched during the molding process. The clamping frame 110 includes a large open region 112 through which a male mold segment or plug 114 is vertically translatable. The male mold segment or plug 114 may include moveable mold components such as corner sections or plugs which may be either a fixed configuration and bi-directionally translatable or may be inflatable bladders to appropriately engage and translate portions of the laminated sheet or panel 44 into intimate contact with the various panels and features defined by the interior surface 102 of the mold assembly 100.

As illustrated in FIG. 1H, the frame 110 is lowered into intimate contact with the upper surface of the sheet or panel 44 and the male mold segment or plug 114 is lowered into the mold cavity of the mold assembly 100. The vacuum pump 108 is activated, thereby drawing the laminated sheet or panel 44 into intimate contact with the interior surface 102 of the mold assembly 100 thereby forming the laminated sheet or panel 44 into the desired final shape of the product.

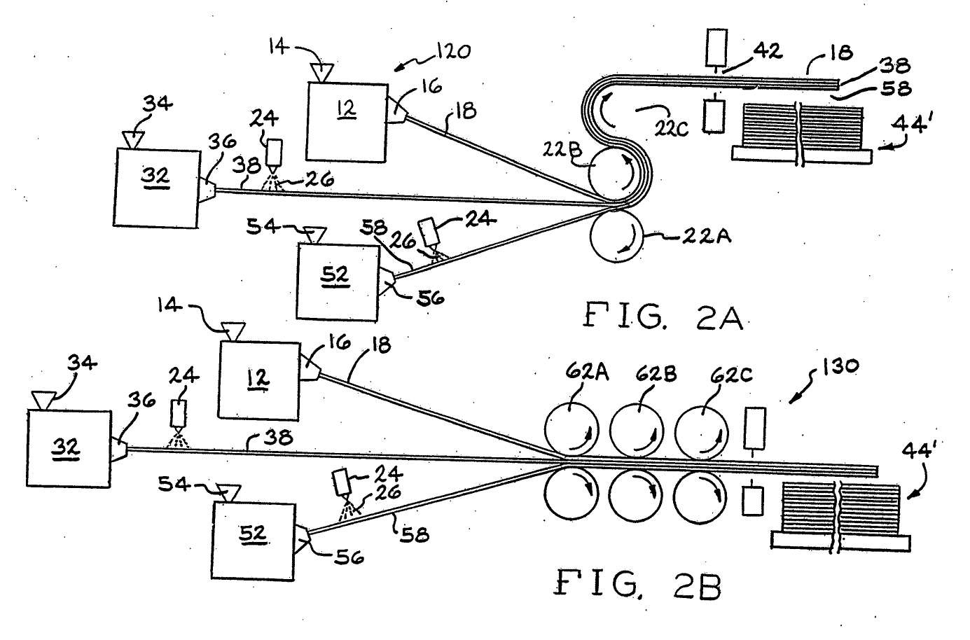

Referring now to FIGS. 2A and 2B, a preferred and first alternate embodiment manufacturing process and equipment is schematically illustrated for the production of three layers extruded and laminated sheets or panels.

With specific regard to FIG. 2A, three separate extruding machines are utilized each having a hopper and an elongate horizontal nozzle from which is ejected a continuous length of extrudate of a particular thermoformable material such as high-density polyethylene (HDPE), thermoplastic olefin (TPO) or other similar material. A first or upper extruding machine 12 includes a hopper 14 for receiving an extrudable thermoplastic and extruding it through an elongate horizontal nozzle 16 with excellent dimensional, i.e., thickness, accuracy. The continuous extruded material 18 from the first or upper extruding machine 12 may have characteristics such as electrical conductivity or anti-slip, i.e. enhanced friction, properties or other desirable characteristics which render it particularly suitable for the uppermost and exposed layer of a product such as a pickup truck bed or bed liner. A second or intermediate, continuously extruded sheet or layer 38 produced by a second or middle extruding machine 32 having a hopper 34 and an elongate, horizontal nozzle 36 will preferably be composed of a material having particularly good structural characteristics such as strength and ruggedness. This may be achieved by, as noted above, adding random fibers or a fibrous mat or the sheet or layer 38. Furthermore, the continuous second extruded sheet or layer 38 may be thicker than the first extruded layer 18 but will exhibit excellent dimensional accuracy. A horizontally extending spray bar having a plurality of nozzles 24, one of which is illustrated in FIG. 2A, optionally provides an adhesive 26 on one surface of the second or intermediate extruded layer 38. A lower or third extruding machine 52 includes a hopper 54 and a horizontal elongate extruding nozzle 56 which produces a third or bottom extruded material layer 58 having excellent dimensional accuracy. Again, a horizontal spray bar having a plurality of nozzles 24 may be utilized to apply an adhesive layer to one surface of the third or bottom extruded layer 58. The third or bottom extruded layer 58 may be fabricated of a material which is relatively soft in comparison to the second or intermediate layer 38. As such, it may provide improved performance with regard to reduced abrading and scratching of the surface of the motor vehicle or pickup truck bed. Furthermore, the third or bottom extruded material layer 58 may be thinner than the middle or intermediate extruded material layer 38. Materials such as linear low density polyethylene, low density polyethylene (LDPE), mixtures thereof, rubber and other elastomers such as ethylene propylene diene monomer (EPDM) or Santoprene® manufactured by Advanced Elastomer Systems of Akron, Ohio are suitable materials for the third or bottom layer 58.

The first or upper extruded material layer 18, the second or intermediate extruded material layer 38 and the third or lower extruded material layer 58 are all provided to a nip between a pair of horizontal, parallel, contra-rotating rollers 22A and 22B whereupon the adhesive 26 contacts adjacent surfaces of the material layers which are then intimately bonded together. As noted above, depending upon the compositions of the layers 18, 38 and 58, if autogenous bonding may be achieved the tying layer of adhesive 26 may be omitted. The rollers 22A and 22B also provide accurate control of the total thickness of the laminate. The three laminated layers then encircle a portion of the middle roller 22B and pass through the nip between the horizontal contra-rotating rollers 22B and 22C. The intimately bonded laminated layers 18, 38 and 58 then pass between a horizontal cutter or cutting assembly 42 which cuts the three layer laminate into panels or sheets 44′ for use in a subsequent process.

FIG. 2B discloses a machine and process 130 whereby the same three layer laminate is made on an apparatus similar to that disclosed in FIG. 1C. The apparatus includes three extruding machines 12, 32 and 52 each having a respective hopper 14, 34 and 54 for receipt of a particular extrudate such as those described above and a horizontal, extruding nozzles 16, 36 and 56 which independently produces a first or upper extruded material layer 18, a second or intermediate extruded material layer 38 and a third or bottom extruded material layer 58, all having excellent dimensional, i.e., thickness accuracy. Once again, elongate, horizontal spray bars having a plurality of nozzles 24, two of which are illustrated, in FIG. 2B may be utilized, if desired, to apply an adhesive 26 to two of the surfaces of the layers, preferably the upper surfaces of the intermediate extruded layer 38 and the upper surface of the lower extruded layer 58. The three layers 18, 38 and 58 then pass through a first pair of vertically aligned, horizontally extending, oppositely rotating rollers 62A where they are intimately bonded together. As noted above, an adhesive 26 may be utilized, or given appropriate conditions, primarily elevated temperature and compatible materials, the pressure applied by the rollers 62A will be sufficient to autogeneously and intimately bond the three layers 18, 38 and 58 together. The three layer laminate then passes through a second pair of vertically aligned, horizontally extending and contra-rotating rollers 62B wherein further bonding of the extruded layers may be achieved. Furthermore, the total thickness of the three layer laminate is accurately controlled by the spacing of the rollers 62A and 62B. Optionally, a third pair of vertically aligned, horizontally extending and contra-rotating rollers 62C may be utilized to further control the thickness of the laminate and to provide, if the rollers 62C are appropriately textured, a grain, texture or other surface treatment to one or both outer surfaces of the three layer laminate as desired.

A cutter or cutting assembly 42 is then utilized to cut the continuous extruded laminate into sheets or panels 44′ which are of a length readily adapted to produce a desired product, such as a cargo bed or pickup truck bed liner as described below.

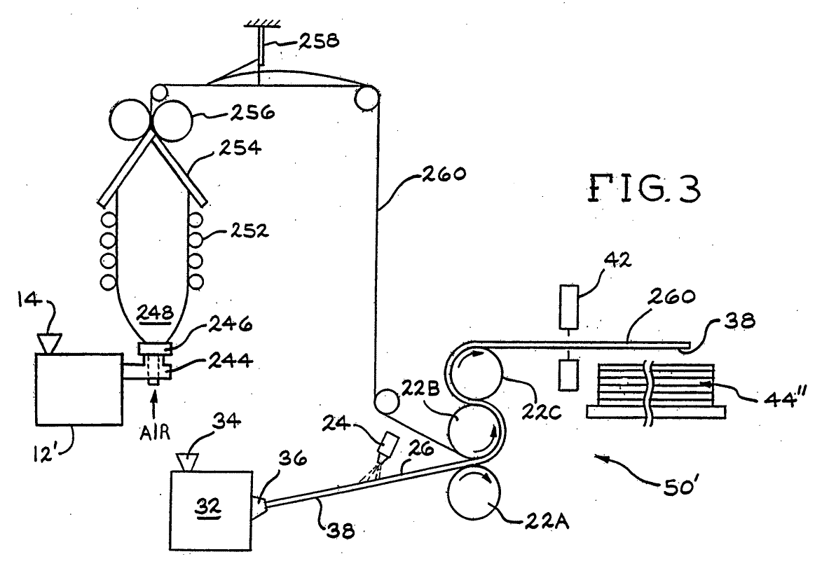

Referring now FIG. 3, a preferred embodiment two layer extruding and laminating process 50′ is illustrated. The preferred embodiment process 50′ is similar in many respects to the preferred embodiment manufacturing process 10 and the first alternate embodiment manufacturing process 50 with the exception that the upper layer 18′ is a blown film or skin having a thickness on the order of less about 0.004″ (0.10 mm) which is manufactured by a typical blown film apparatus and then adhered to a lower extruded substrate 38. The blown film process and apparatus includes an extruder 12′ having a hopper 14 which receives a supply of suitable, thermoplastic material in bulk. Various thermoplastic materials such as polyethylenes and polyolefins may be utilized. If a soft film is desired, partially crosslinked thermoplastic olefins may be used. The extruder 12′ is fitted with a tubular die 244 which receives the extruded material and forms it into a cylinder about a vertical axis. The extruding machine 12′ also includes a cooling ring 246 adjacent the tubular die 244. Compressed air is supplied through the tubular die 244 and the cooling ring 246 to the interior of an extruded cylinder of thermoplastic material 248. The compressed air enlarges the diameter of the cylinder of thermoplastic material 248 as it moves upwardly and is received within a sizing basket 252. The sizing basket 252 limits the outward expansion of the cylinder of thermoplastic material 248 while further cooling it. The cylinder of thermoplastic material 248 then moves to a pair of symmetrically disposed collapsing guides which change the shape of the extruded and blown film of thermoplastic material 248 from a cylinder into a continuous flat sheet having two layers. A pair of rollers 256 draws the extruded and blown film of thermoplastic material 248 from the sizing basket 252. A slitter 258 then opens the flattened cylinder and rolls the blown film of thermoplastic material 248 out into a single layer of blown skin or film 260.

The single layer of blown skin or film 260 is then provided to the nip between a pair of contra-rotating rollers 22A and 22B as an upper layer. The preferred embodiment two layer process 50′ also utilizes a second extruding machine 32 having a hopper 34 and an elongate, horizontal extrusion nozzle 36 which produces a continuous web or sheet of extruded material 38 of excellent dimensional, i.e., thickness accuracy. The extruded material 38 is likewise provided to the nip between the rollers 22A and 22B. Depending upon the temperature of the blown film 260 and other variables such as the types of materials, they may be autogeneously bonded between the contra-rotating rollers 22A and 22B. Optionally, an elongate horizontal spray bar which includes a plurality of nozzles 24, one of which is illustrated in FIG. 3, may be utilized to provide an adhesive layer 26 to one surface of the extruded material 38 prior to its engagement with the film 260 and passing through the nip of the vertically aligned, horizontal, contra-rotating rollers 22A and 22B. Next, the continuous web or sheet of blown film 260 and extruded material 38 pass through a second nip between the contra-rotating rollers 22B and 22C. Then, the laminated blown and extruded layers 260 and 38 pass through a cutter or cutting assembly 42 and are cut into uniform desired lengths of sheets or panels 44″.

The thermoplastic material from which the blown film 260 is made may be treated or mixed with various materials to impart a desirable surface feature to the sheet or panel 44″ such as electrical conductivity to achieve static dissipation or enhanced frictional characteristics to provide a non-skid or non-slip surface to the sheets or panels 44″. In the case of the former, conductive materials such as carbon black or conductive polymers may be added to the thermoplastic. Additionally, the blown film 260 may provide a smooth, glossy surface to the final product. The blown film 260 may typically be manufactured to a thickness tolerance of ±8% or less.

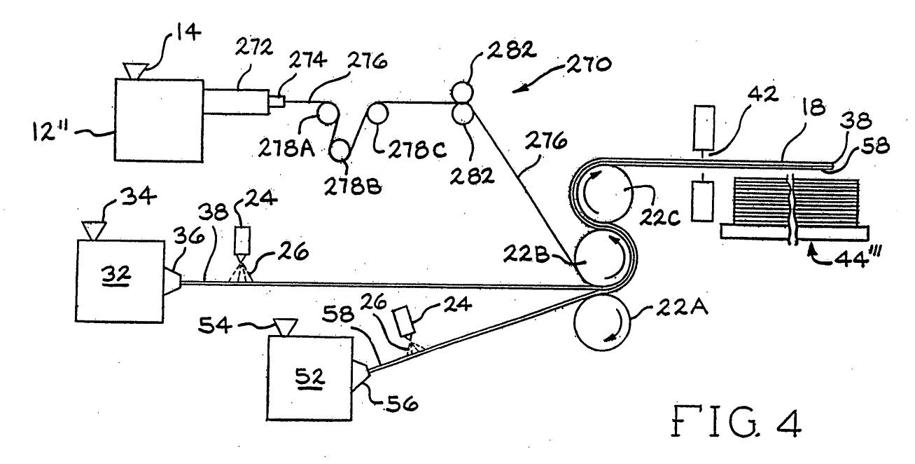

Referring now to FIG. 4, a preferred embodiment manufacturing apparatus process 270 for the manufacture of a three layer laminate having a cast first or upper layer film is illustrated. The preferred embodiment apparatus and process 270 is similar in many respect to the preferred and alternate embodiment manufacturing processes and apparatus 120 and 130 illustrated above for the production of three layer extruded and laminated sheets or panels. The preferred embodiment apparatus 270 includes an extruding machine 12″ having a hopper 14 for receiving thermoplastic material. The above descriptions of materials and additives utilized to produce, for example conductive or smooth, glossy blown film 260 applies equally with regard to cast film 276. A barrel 272 of the extruding machine 12″ feeds into a clothes hanger 274 which is a die configuration which redirects the flow of extrudate from the generally cylindrical flow within the barrel 272 of the extruding machine 12″ to a wide and relatively thin, on the order of 0.004 inches (0.010 mm), layer while inducing minimal shear in the extrudate and the cast film layer 276. The cast film 276 then wraps around and travels in a sinuous path over three horizontal, elongate cooling rollers 278A, 278B and 278C. The cooled, cast film layer 276 then passes through the nip of a pair of horizontal, contra-rotating puller rollers 282. The cast film layer 276 may typically be manufactured to a thickness of +3% or less.

The manufacturing apparatus 270 also includes a second extruding machine 32 having a hopper 34 and horizontal elongate extruding nozzle 36 which produces an intermediate extruded layer 38 of excellent dimensional accuracy which may include an adhesive 26 provided over its surface by a plurality of spray heads 24, one of which is illustrated in FIG. 4. An additional extruding machine 52 includes a hopper 54 and an elongate horizontal extrusion nozzle 56 which produces a bottom extruded layer 58 of excellent dimensional accuracy which may also includes an adhesive 26 provided by a plurality of spray heads 24 one of which is illustrated.

The cast, upper film layer 276, the intermediate extruded layer 38 and the bottom extruded layer 58 are all provided to a nip between a pair of horizontal, elongate, contra-rotating rollers 22A and 22B where they are, first of all, intimately bonded, either autogeneously or through the agency of the adhesive 26 and, second of all, compressed to a controlled, desired thickness. The three layer laminate is then provided to the nip between the horizontal, elongate, contra-rotating rollers 22B and 22C where a second controlled roller spacing again compresses the three layers of the laminate and accurately controls its thickness. Finally, the three layer laminate consisting of the upper cast film 276, the middle extruded layer 38 and the lower extruded layer 58 passes through a cutter or cutting assembly 42 and is cut into suitable lengths for desired sheets or panels 44′″.

It will be appreciated that the blown film, cast film and extruded substrate processes 50′ and 270 which have been disclosed as alternatives to the processes illustrated in FIGS. 1B and 2A, respectively, may be readily utilized with the other roller configurations and processes illustrated in FIG. 1A, 1C or 2B, respectively, and that the blown film 260 may be utilized in a three layer laminate process such as manufactured in the process 120 and 130 and, that the cast film 276 may be utilized in a two layer laminate such as manufactured in the process 10, 50 and 60.

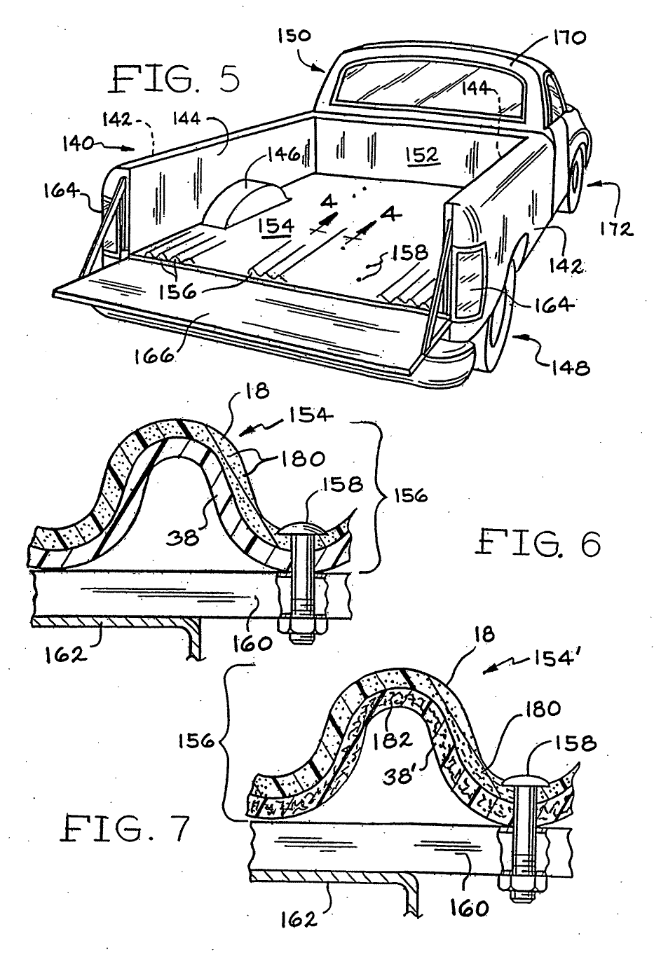

Referring now to FIGS. 5, 6 and 7, a non-metallic pickup truck bed manufactured according to the present invention is illustrated and designated by the reference number 140. The non-metallic pickup truck bed 140 is a unitary, laminated structure preferably molded of an engineered thermoplastic such as high density polyethylene (HDPE) polypropylene or similar material as described above. The pickup truck bed 140 includes outer sidewalls 142 which merge smoothly with opposed generally parallel inner sidewalls 144. The inner sidewalls 144 are interrupted by wheel wells 146 which are suitably sized and located to accommodate the respective rear tire and wheel assemblies 148 of a pickup truck 150 or similar light to medium duty cargo vehicle. The opposed inner sidewalls 144 merge with a transversely extending front wall 152 which may define a single panel interconnecting and merging with the inner opposed sidewalls 144 or a double wall panel having inner and outer panels which interconnect and merge with respective ones of the inner sidewalls 144 and the outer sidewalls 142. The pair of inner sidewalls 144 and the transverse front wall 152 all merge with and are interconnected by a floor or bottom panel 154.

To improve the strength and rigidity of the bottom panel 154, it preferably defines a plurality of corrugations 156 which extend longitudinally substantially its full length. A plurality of fasteners such as carriage bolts 158 or other fastening devices extend through the bottom panel 154 and secure the pickup truck bed 140 to transverse braces or members 160 which are, in turn, secured to a frame or undercarriage 162 of the pickup truck 150. Preferably and typically, the non-metallic pickup truck bed 140 includes backup and tail light assemblies 164 which function in accordance with conventional practice. A tailgate assembly 166 is pivotally disposed across the open end of the pickup truck bed 140. The pickup truck 150 also includes a conventional cab 170 and front tire and wheel assemblies 172.

Referring now to FIG. 6, a portion of the plurality of corrugations 156 of the bottom panel 154 are illustrated in cross-section. In FIG. 6, the bottom panel 154 which includes two layers of distinct materials which have been extruded into continuous sheets, laminated, cut and then formed into the desired size and configuration according to the methods described above, may include a first layer 18 having electrically conductive particles 180 of carbon black or other electrically conductive material which are shown greatly enlarged for purposes of illustration. If carbon black, the conductive particles or material 180 may be like or similar to the product designated XC-72 manufactured by the Cabot Corporation or the product designated Ketjenblack EC-300 J manufactured by Akzo Nobel Chemicals, Inc. Other conductive materials such as carbon fibers or tendrils, conductive polymers such as Irgastat P18 manufactured by Ciba Specialty Chemicals or conductive metal materials such as aluminum or copper powders or flakes are also suitable.

Preferably, the conductive particles 180 of carbon black represent approximately 18% to 22% of the total weight of material. Depending upon the particular choice of conductive material and plastic, however, conductive particles 180 in the range of 5% to 25% by weight may be utilized. When a coarser carbon black such as Cabot's XC-72 is used, 18% to 22% carbon black by weight has produced good performance. Finer carbon black such as Akzo Nobel's Ketjenblack EC-300 J provides similar performance when utilized at about 8% to 12% by weight. Regardless of the types of conductive material and plastic they utilized, the resulting upper or first layer 18 should exhibit surface resistivity of no more than 1×10⁹ ohms and preferably less or volume resistivity of no more than 1×10⁹ ohm-cm and preferably less.

It should be understood that higher weight percentages of conductive material lower both the surface and volume resistivities and vice versa. However, mixtures having conductive material above the weight percentages stated and resistivity significantly below those stated do not appear to confer any additional performance benefit.

Intimately secured to the first or upper layer 18, by an adhesive or through the agency of autogenous bonding is a second or lower layer 38 of material which may be characterized as a substrate layer. Preferably, this second or lower layer 38 is uniform and of a substance such as HDPE or other material similar to the first layer 18 except that it is virgin or undoped and thus typically provides slightly greater strength. Moreover, because it does not include a doping agent to provide electrical conductivity, it is less expensive for a given size or weight than the upper or first layer 18.

Referring now to FIG. 7, a portion of a second embodiment of the pickup truck bed 140′ is illustrated and designated by the reference number 140′. The second embodiment of the pick-up truck bed 140′ includes the first or upper layer 18 which includes conductive particles 180 such as carbon black or other electrically conductive material such as described above. Intimately adhered to the first or upper layer 18 by an adhesive or autogenous bonding is a second or lower layer 38′. The second or lower layer 38′ again may be a suitable rugged and temperature stable thermoplastic such as HDPE. However, the HDPE or other suitable plastic has been mixed with and includes reinforcing fibers 182 such as fiberglass or other fibers which increases the strength and ruggedness of the HDPE or other plastic material.

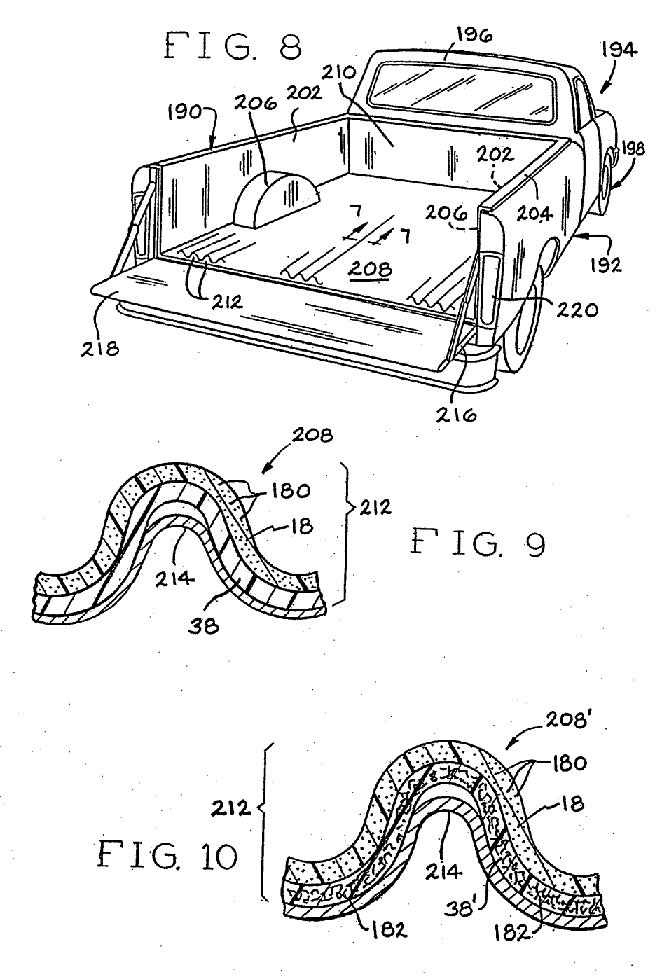

Referring now to FIGS. 8, 9 and 10, a third embodiment pickup truck bed liner is illustrated and designated by the reference number 190. A third embodiment pickup truck bed liner 190 is utilized in the conventional metal 192 of a pickup truck 194 having a cab 196 and front tire and wheel assemblies 198. The bed liner 190 includes sidewalls 202 which may include an upper rail 204, a pair of opposed wheel wells 206 extending between the sidewalls 202 and a floor or bottom panel 208. The floor or bottom panel 208 merges with both the sidewalls 202 and a front wall 210. The floor or bottom panel 208 preferably includes corrugations 212 complementary to the corrugations 214 of the pickup truck bed 1962. A tailgate assembly 216 may include a protective cover 218 fabricated of similar material. The pickup truck 194 also includes conventional tail light assemblies 220.

Referring now to FIG. 9, a portion of the third embodiment pickup truck bed liner 190 illustrating the corrugations 212 which, as noted, are complementarily to the corrugations 214 of the pickup truck bed are illustrated in cross-section. In FIG. 10, the bottom panel 208 which includes two layers of distinct materials but may also include three layers of distinct materials, have each been extruded into continuous sheets, laminated, cut and then formed into the desired size and configuration truck bed liner 190 according to the methods described above. The bottom panel 208 as well as the remainder of the truck bed liner 190 preferably includes a first layer 18 having electrically conductive particles 180 of carbon black or other electrically conductive material as described above. Intimately secured to the first or upper layer 18 by an adhesive or through the agency of autogenous bonding is a second or lower layer 38 of material which may be characterized as a substrate layer. Preferably, the second or lower layer 38 is uniform and of a substance such as HDPE or other material similar to the first layer 18 except that it is undoped, i.e., it is nominally pure HDPE and thus typically provides slightly greater strength than the first or upper layer 18. Furthermore, because it does not include an agent which provides electrical conductivity, it is less expensive for a given size, thickness or weight than the upper or first layer 18.

Because the bed liner 190 is supported by and resides within the bed 192 of a pickup truck 194, a three layer sandwich or composite having a soft, resilient or compliant third layer 58 may be desirable to provide added protection to the truck bed 192 and the paint disposed thereon. Manufacture of such a three layer laminate and bed liner from such laminate is described above.

Referring now to FIG. 10, a portion of a fourth pick up truck bed liner is illustrated and designated by the reference number 190′. The fourth embodiment of the pickup truck bed liner 190′ includes the first or upper layer 18 which includes conductive material 180 such as carbon black or other electrically conductive material such as described above. Intimately adhered to the first or upper layer by an adhesive or autogenous bonding is a second or lower layer 38′. The second or lower layer 38′ again may be a suitable, rugged and temperature stable thermoplastic such as HDPE. However, the HDPE or other suitable plastic has been mixed with and includes reinforcing fibers 182 such as fiberglass or other fibers which increases the strength and ruggedness of the HDPE or other plastic material. Once again, because the fourth embodiment bed liner 190′ is utilized with a truck bed 192, it may be desirable to utilize the three layer laminate having an additional soft, resilient or compliant layer 58 as described above.

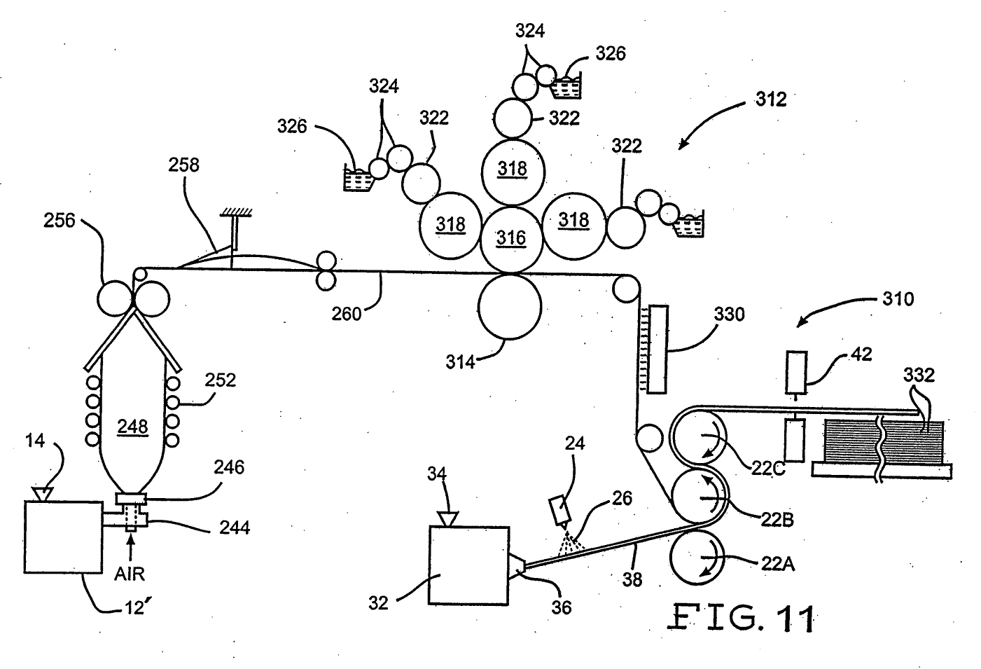

Referring now to FIG. 11, an additional embodiment two layer blown film extruding, printing and laminating process and apparatus 310 is illustrated. This additional embodiment process and apparatus 310 is similar in many respects to the preferred embodiment two layer extruding and laminating process 50′ illustrated in FIG. 3. The blown film extruding, printing and laminating process and apparatus 310 includes an extruding machine 12′ having a hopper 14 which receives a supply of a suitable, typically pelletized, thermoplastic material in bulk. The thermoplastic material may be polyethylene, or other materials. If a soft finish is desired, partially crosslinked thermoplastic olefins may be used. The thermoplastic material may be lacking any coloring pigment and thus produce a clear film or it may include color pigment such as black, red, green, yellow or other colors such that a black or colored film is produced. The extruding machine 12′ is fitted with a tubular die 244 which receives the extruded material and forms it into a cylinder about a vertical axis. The extruding machine 12′ also includes a cooling ring 246 adjacent the tubular die 244. Compressed air is supplied to and through the tubular die 244 and the cooling ring 246 to the interior of an extruded cylinder of thermoplastic material 248. The compressed air stretches the thermoplastic material 248 and enlarges the diameter of the cylinder of thermoplastic material 248 as it moves upwardly and is received within a sizing basket 252. The sizing basket 252 limits the outward expansion of the cylinder of thermoplastic material 248 while further cooling it.

A cylinder of thermoplastic material 248 then moves to a pair of symmetrically disposed collapsing guides 256 which change the shape of the extruded and blown film of thermoplastic material 248 from a cylinder into a continuous flat sheet having two layers. The pair of collapsing guides 256 draws the extruded and blown film of thermoplastic material 248 from the sizing basket 252. A slitter 258 then opens the flattened cylinder and rolls the blown film of thermoplastic material 248 out into a flat, single layer of blown skin or film 260.

The flat, single layer blown film 260 then proceeds to an offset printing apparatus 312. The offset printing apparatus 312 is preferably a relatively conventional one, two, three or greater color offset printing apparatus having an impression roller 314 and a blanket roller 316 which form a nip through which the single layer film 260 passes. The blanket roller 316 receives offset printing ink in the desired pattern from a plurality of plate rollers 318 and prints onto one surface of the film 260 as will be readily appreciated. The offset printing apparatus 312 illustrated includes components to facilitate printing of three colors. As noted, more or fewer colors may be printed onto the film 260 in, for example, camouflage patterns, other aesthetic and decorative patterns and designs and indicia and logotypes to name but a few. As such, each of the various color ink supplies include a form roller 322, two ink train rollers 324 and an ink well 326. Preferably, the ink well 326 to the left of the drawing will contain and supply the lighter color ink and the ink well 326 to the right of the drawing will contain and supply the darker or darkest colored ink. The details of offset printing and the offset printing apparatus employed herein are deemed to be conventional and thus will not be further described.

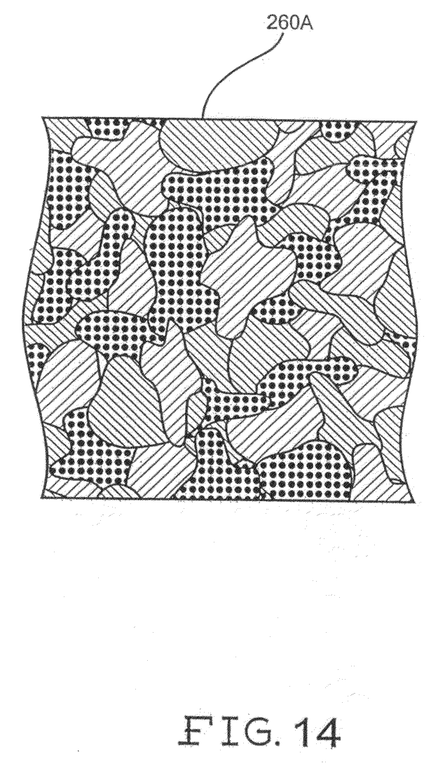

FIG. 14 presents an exemplary camouflage pattern which may be printed upon the film 260A and is typical of camouflage patterns. It includes random and irregular regions of three distinct colors such as black, green and brown or tan, for example. As noted above, the film 260 may itself be black or colored, if desired. Also, as noted, the pattern or indicia printed upon the film 260A may be decorative or may include text or commercial features such as logotypes and trademarks or other patterns or designs.

Subsequent to printing, the printed thin film 260A including the printed material or information preferably passes adjacent a convection or a radiation type heater 330 which heats and dries the ink. The single layer of printed blown film 260A is then provided to the nip between a pair of contra-rotating rollers 22A and 22B as an upper layer. A second extruding machine 32 having a hopper 34 and an elongate, horizontal extrusion nozzle 36 produces a continuous web or sheet of extruded material 38 having excellent dimensional, i.e., thickness accuracy. The extruded material 38 may be fairly characterized as the substrate of the final product and structurally therefore it must exhibit sufficient strength and ruggedness in and of itself so that the final product to exhibit appropriate strength and serviceability. Accordingly, the extruded material 38 is preferably formed of high density polyethylene (HDPE) or high density polyethylene and may include randomly oriented glass fibers or a fiberglass or fibrous mat.

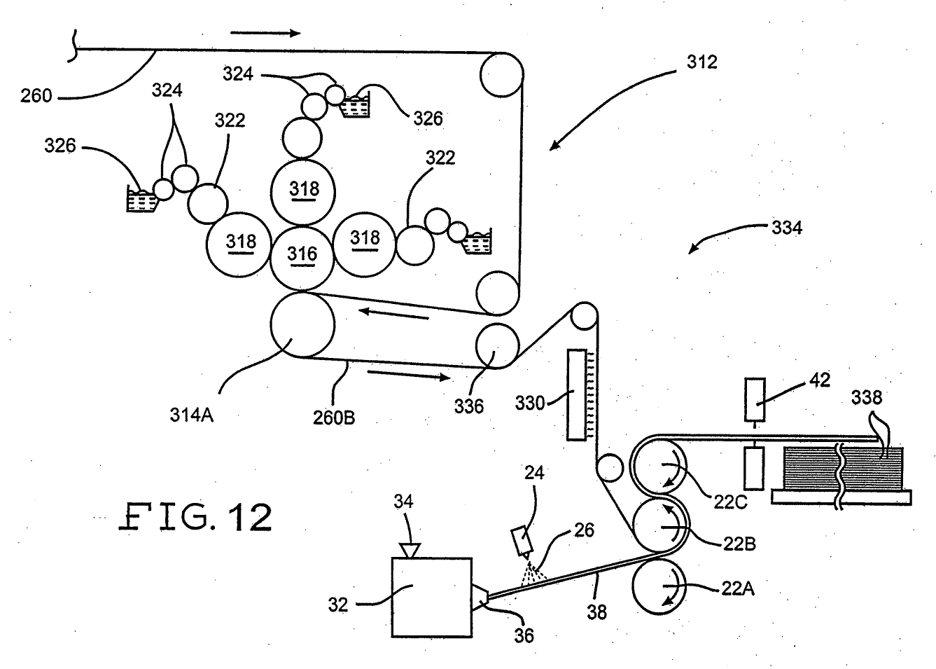

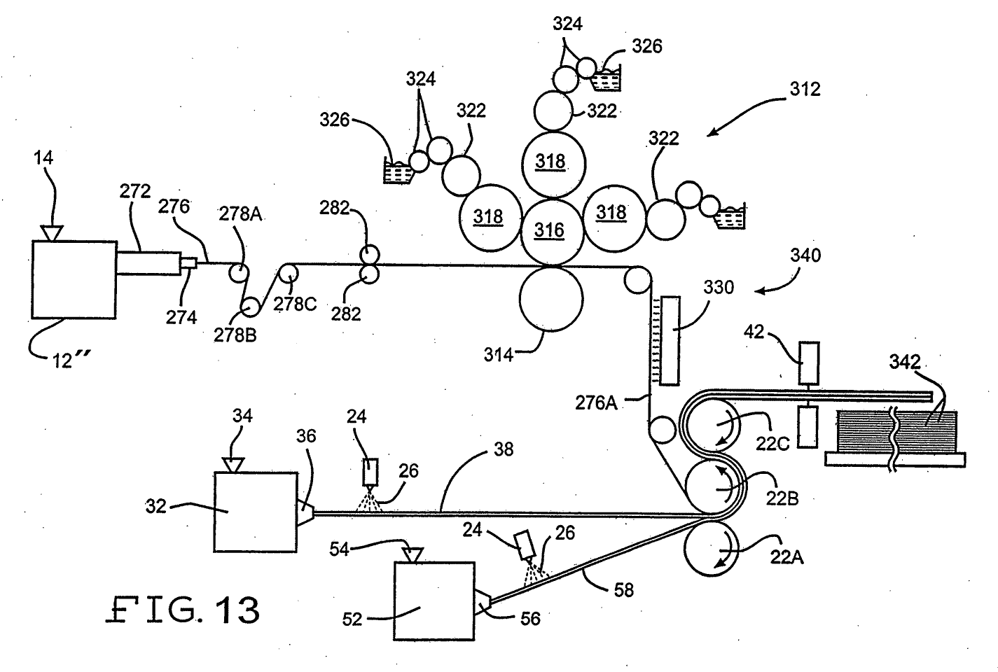

The extruded material 38 is also provided to the nip between the rollers 22A and 22B. Depending upon the temperature of the blown and printed film 260A and other variables such as the type of materials, they may be autogeneously bonded between the contra-rotating rollers 22A and 22B. Optionally, an elongate horizontal spray bar which includes a plurality of nozzles 24, one of which is illustrated in FIG. 12, may be utilized to provide an adhesive layer 26 to one surface of the extruded material 38 prior to its engagement with the blown and printed film 260A and prior to passing through the nip of the vertically aligned, horizontal, contra-rotating rollers 22A and 22B. Next, the continuous web or sheet of blown and printed film 260A and extruded material 38 pass through a second nip between the contra-rotating rollers 22B and 22C. Finally, the laminated, blown, printed and extruded layers 260A and 38 pass through a cutter or cutting assembly 42 and are cut into uniform desired lengths of sheets or panels 332.

Referring now to FIG. 12, an alternate embodiment blown film extruding, printing and laminating process and apparatus 334 is illustrated. This alternate embodiment process and apparatus 334 is similar in nearly all respects to the additional embodiment two layer blown film extruding, printing and laminating process and apparatus 310 described directly above except that the film 260 is rerouted after printing such that the printed material is on the lower face of the film 260, protected by the film 260 itself when it is laminated to the extruded layer 38. Thus, the film 260 is produced and prepared as illustrated in FIG. 11, above, and then passed through the offset printing apparatus 312 which again includes one or more colors which are transferred to the film 260 at an impression roller 314A about which the film 260 substantially wraps. The offset printing apparatus 312 includes a blanket roller 316, a plurality of plate rollers 318, a plurality of form rollers 322, a plurality of ink train rollers 324 and a plurality of ink wells 326 containing various, desired colors of ink.

The printed film 260B is entrained about an additional guide roller 336, and is passed adjacent a convention or radiation heater 330 which heats and dries the ink. The printed film 260B wherein the indicia, printing or pattern is on the left face of the printed film 260B as illustrated in FIG. 12, then engages the roller 22A and is bonded to the continuous web or sheet of extruded material 38 exiting a second extruding machine 32 having a hopper 34 and an elongate horizontal extrusion nozzle 36. The printed film 260B may be autogeneously bonded to the continuous web or sheet of extruded material 38 between the rollers 22A and 22B or an adhesive layer 26 which may be supplied to the upper surface of the extruded material 38 by a plurality of nozzles 24 may be utilized to ensure a tight and positive bond between the extruded material 38 and the printed film 260B. In a manner similar to that described above with regard to FIG. 11, a cutter cutting assembly 42 cuts the blown, laminated, extruded and printed layers 260B and 38 into uniform desired lengths of sheets for panels 338. It will be appreciated that so fabricated, the film 260 protects the printed pattern, indicia, logos and thereby maintains its appearance during its life. Lastly, it should be understood that the single extruded layer 38 with printing on the underside of the film 260B may be augmented with an additional extruded layer as illustrated in FIG. 13, below.

Referring now to FIG. 13, an additional embodiment manufacturing apparatus and process 340 for the manufacture of a three layer laminate having a printed and cast first or upper layer film is illustrated. The preferred embodiment apparatus and process 340 is similar in many respect to the preferred and alternate embodiment manufacturing processes and apparatus 120, 130 and 270 illustrated above for the production of three layer extruded and laminated sheets or panels. The preferred embodiment apparatus 340 includes an extruding machine 12″ having a hopper 14 which receives a supply of a suitable, typically pelletized, thermoplastic material in bulk. A barrel 272 of the extruding machine 12″ feeds into a clothes hanger die 274 which is a die configuration which redirects the flow of extrudate from the generally cylindrical flow within the barrel 272 of the extruding machine 12″ to a wide and relatively thin, on the order of 0.004 inches (0.010 mm), layer while inducing minimal shear in the extrudate and a cast film 276 produced therein. The cast film 276 then wraps around and travels in a sinuous path over three horizontal, elongate cooling rollers 278A, 278B and 278C. The cast film 276 then passes through the nip of a pair of horizontal, contra-rotating puller rollers 282. The cast film layer 276 may typically be manufactured to a thickness of ±3% or less.

The cast film 276 then proceeds to an offset printing apparatus 312. The offset printing apparatus 312 is preferably a relatively conventional one, two, three or greater color offset printing apparatus having an impression roller 314 and a blanket roller 316 which form a nip through which the single layer cast film 276 passes. The blanket roller 316 receives offset printing ink in the desired pattern from a plurality of plate rollers 318 and prints onto one surface of the film 276 as will be readily appreciated. The offset printing apparatus 312 illustrated includes components to facilitate printing of three colors. As noted, more or fewer colors may be printed onto the film 276 in, for example, camouflage patterns, other aesthetic and decorative patterns and designs and indicia and logotypes to name but a few. As such, each of the various color ink supplies include a form roller 322, two ink train rollers 324 and an ink well 326. Preferably, the ink well 326 to the left of the drawing will contain and supply the lighter color ink and the ink well 326 to the right of the drawing will contain and supply the darker or darkest colored ink. The details of offset printing and the offset printing apparatus employed herein are deemed to be conventional and thus will not be further described.

The manufacturing apparatus 340 also includes a second extruding machine 32 having a hopper 34 and horizontal elongate extruding nozzle 36 which produces an intermediate extruded layer 38 of excellent dimensional accuracy which may include an adhesive 26 provided over its surface by a plurality of spray heads 24, one of which is illustrated in FIG. 13. An additional extruding machine 52 includes a hopper 54 and an elongate horizontal extrusion nozzle 56 which produces a bottom extruded layer 58 of excellent dimensional accuracy which may also includes an adhesive 26 provided by a plurality of spray heads 24 one of which is illustrated.

The printed and cast, upper film layer 276A, the intermediate extruded layer 38 and the bottom extruded layer 58 are all provided to a nip between a pair of horizontal, elongate, contra-rotating rollers 22A and 22B where they are, first of all, intimately bonded, either autogeneously or through the agency of the adhesive 26 and, second of all, compressed to a controlled, desired thickness. The three layer laminate is then provided to the nip between the horizontal, elongate, contra-rotating rollers 22B and 22C where a second controlled roller spacing again compresses the three layers of the laminate and accurately controls its thickness. Finally, the three layer laminate consisting of the upper printed and cast film 276A, the middle extruded layer 38 and the lower extruded layer 58 pass through a cutter or cutting assembly 42 and is cut into suitable lengths for desired sheets or panels 342.

While the various extruded and blown and cast film layers 18, 38, 58, 260 and 276 and the resulting laminated sheets or panels 44, 44′ and 44″ have been described above as being especially suited for subsequent thermoforming into truck beds and truck and van bed liners, it should be understood that such sheets or panels 44, 44′ and 44″ may be utilized to fabricate by thermoforming or other similar processes a broad range of vehicular and static structure panels and features such as tops, covers, bulkheads, floorboards, interior panels, cabinets, cabinet faces, doors, separators, dividers, housings and containers having single or multi-color printed patterns or indicia appearing thereon.

The foregoing disclosure is the best mode devised by the inventors for practicing this invention. It is apparent, however, that products and methods incorporating modifications and variations will be obvious to one skilled in the art of truck beds, bed liners and manufacturing processes therefor. Inasmuch as the foregoing disclosure presents the best mode contemplated by the inventor for carrying out the invention and is intended to enable any person skilled in the pertinent art to practice this invention, it should not be construed to be limited thereby but should be construed to include such aforementioned obvious variations and be limited only by the spirit and scope of the following claims

We claim:

1. A method of fabricating a laminated product comprising the steps of:
forming a first thermoplastic material into a first continuous layer having a surface,
printing a pattern onto said surface of said first layer, extruding a second thermoplastic material into a second continuous sheet,
compressing said first continuous layer and said second continuous sheet together to form a continuous laminated sheet,
cutting said continuous laminated sheet into a plurality of laminated panels, and
thermoforming at least one of said laminated panels.

2. The method of claim 1 wherein said second thermoplastic material is electrically conductive.

3. The method of claim 1 wherein said second thermoplastic material is high density polyethylene.

4. The method of claim 1 wherein said first layer is formed by blowing, casting or extruding.

5. The method of claim 1 wherein said pattern on said surface of said first layer is camouflage.

6. The method of claim 1 further including the step of extruding a third thermoplastic material distinct from said first and said second thermoplastic materials into a third continuous sheet and laminating said first continuous layer and said second and third continuous sheets.

7. The method of claim 6 wherein said third extruded material sheet provides cushioning to said first layer and said second sheet.

8. The method of claim 6 further including the step of applying an adhesive to one face of each of said two continuous sheets prior to said laminating step.

9. The method of claim 6 wherein said first layer defines a soft, glossy top surface.

10. The method of claim 1 further including the step of applying an adhesive to one face of one of said continuous sheets of thermoplastic material.

11. The method of claim 1 wherein said laminated panels are formed into liners for cargo vehicles.

12. The method of claim 1 further including the step of heating said laminated panels prior to said thermoforming step.

13. The method of claim 1 wherein said first thermoplastic material is distinct from said second thermoplastic material.

14. A method of fabricating a laminated bed liner comprising the steps of
forming a first layer of a first thermoplastic material having a first property,
printing onto said first layer,
extruding a second sheet of a second thermoplastic material having a second property distinct from said first property,
laminating said first layer and said second sheet of thermoplastic material,
cutting said laminated sheet of thermoplastic materials into panels, and
forming at least one of said laminated panels into a bed liner.

15. The method of claim 14 wherein said first property is transparency.

16. The method of claim 14 wherein said printing step prints a pattern or indicia.

17. The method of claim 14 further including the step of applying an adhesive to one face of one of said layer or sheet of thermoplastic material.

18. The method of claim 14 wherein said first layer is formed by blowing, casting or extruding.

19. The method of claim 14 wherein said printing is done in at least two colors.

20. The method of claim 14 further including the step of extruding a third thermoplastic material having a third property distinct from said properties of said first and said second thermoplastic materials into a third sheet and laminating said first layer and second and third sheets.

21. The method of claim 20 wherein said third extruded material layer provides cushioning to said first and said second material layers.

22. The method of claim 20 further including the step of applying an adhesive to one face of two of said sheets of thermoplastic material.

23. The method of claim 20 wherein said printing is on the underside of said film.

24. The method of claim 20 wherein said first layer is partially crosslinked thermoplastic olefin.

25. The method of claim 20 wherein said first layer is smooth and glossy.

26. The method of claim 20 wherein said first layer is softer than said second layer.
